(19) United States
(12) Patent Application Publication
(10) Pub. No.: US 2026/0042347 A1
(43) Pub. Date: Feb. 12, 2026

(54) VEHICULAR REARVIEW MIRROR ASSEMBLY WITH INTEGRATED TOUCH SENSORS

(71) Applicant: Magna Mirrors of America, Inc., Holland, MI (US)

(72) Inventors: Austen C. Peterson, Hudsonville, MI (US); Anthony J. LaCross, Hastings, MI (US); Eric Peterson, West Olive, MI (US)

(21) Appl. No.: 19/289,314

(22) Filed: Aug. 4, 2025

Related U.S. Application Data
(60) Provisional application No. 63/679,706, filed on Aug. 6, 2024.

(51) Int. Cl. B60K 35/10; B60K 35/22; B60Q 3/258; B60R 1/04

(52) U.S. Cl. CPC B60K 35/10; B60K 35/22; B60Q 3/258; B60R 1/04

(57) ABSTRACT

A vehicular interior rearview mirror assembly includes a mirror head adjustable about a mounting base that is configured to mount the vehicular interior rearview mirror assembly at an interior portion of a vehicle. The mirror head accommodates a mirror casing and a mirror reflective element. A sensor casing is formed separate from the mirror casing and includes a plurality of capacitive touch sensors encapsulated within a wall structure of the sensor casing. The sensor casing is attached to the mirror casing such that an outer surface of the wall structure includes an outer surface of the mirror head. A system of the vehicle is controlled responsive to a user input at a portion of the outer surface of the wall structure of the sensor casing that corresponds to one or more of the plurality of capacitive touch sensors.

### CROSS REFERENCE TO RELATED APPLICATION

The present application claims the filing benefits of U.S. provisional application Ser. No. 63/679,706, filed Aug. 6, 2024, which is hereby incorporated herein by reference in its entirety.

### FIELD OF THE INVENTION

The present invention relates generally to the field of rearview mirror assemblies for vehicles and, more particularly, to interior rearview mirror assemblies with touch sensor inputs.

### BACKGROUND OF THE INVENTION

It is known to provide a mirror assembly that is adjustably mounted to an interior portion of a vehicle, such as via a pivot joint mounting configuration where the mirror head and reflective element are adjusted relative to the interior portion of a vehicle by pivotal movement about one or more pivot joints. The mirror head and reflective element are pivotable about the pivot joint by a user that is adjusting the user's rearward view. The mirror head of the mirror assembly may accommodate one or more user actuatable inputs, such as for controlling a video display or garage door opener of the vehicle.

### SUMMARY OF THE INVENTION

A vehicular interior rearview mirror assembly includes a mirror head adjustably disposed at a mounting base configured to mount the vehicular interior rearview mirror assembly at an interior portion of a vehicle. The mirror head accommodates a mirror casing and a mirror reflective element. A sensor casing includes a plurality of capacitive touch sensors encapsulated within a wall structure of the sensor casing. The sensor casing may be formed distinct and separate from the mirror casing and is attached at the mirror casing so that an outer surface of the wall structure of the sensor casing provides an outer surface of the mirror head.

The capacitive touch sensors are formed within the sensor casing, such as by (i) screen printing circuitry on a thermoformable film and (ii) overmolding a polymeric material over the thermoformable film to encapsulate the plurality of capacitive touch sensors within the wall structure of the sensor casing. The thermoformable film may be shaped into a three-dimensional shape before overmolding the polymeric material.

These and other objects, advantages, purposes and features of the present invention will become apparent upon review of the following specification in conjunction with the drawings.

### BRIEF DESCRIPTION OF THE DRAWINGS

FIG. 1 is a view of an interior rearview mirror assembly;

FIG. 2 is a view of a rear side of the mirror assembly of FIG. 1;

FIGS. 3 and 4 are rear views of the mirror assembly, shown with portions removed or transparent to show additional details;

FIG. 5 is a perspective view of a lower mirror casing portion with apertures formed through the lower mirror casing portion to accommodate user inputs;

FIG. 6 is a perspective view of a lower mirror casing portion with touch sensors integrated into the lower mirror casing portion; and

FIG. 7 is a perspective view of a mirror reflective element assembly, showing the electrical connection of the lower mirror casing portion to the circuit board of the mirror reflective element assembly.

### DESCRIPTION OF THE PREFERRED EMBODIMENTS

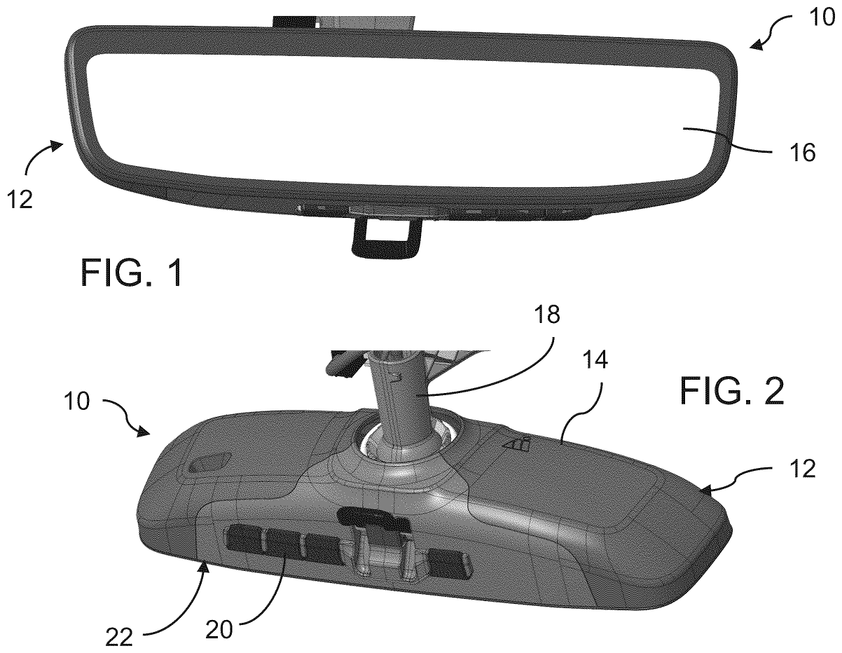

Referring now to the drawings and the illustrative embodiments depicted therein, an interior rearview mirror assembly 10 for a vehicle includes a mirror head 12 having a mirror casing 14 and a reflective element 16 positioned at a front portion of the casing 14 (FIGS. 1 and 2). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element may include a variable reflectance mirror reflective element that varies its reflectance responsive to electrical current applied to conductive coatings or layers of the reflective element.

The interior mirror assembly comprises a dual-mode interior rearview video mirror that can switch from a traditional reflection mode to a live-video display mode, such as by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

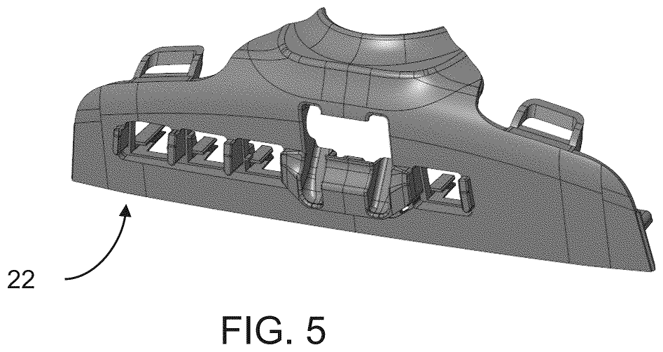

The mirror head may accommodate a plurality of user-actuatable inputs or buttons 20, which are disposed at a lower or chin region of the mirror head. As shown in FIGS. 2-5, a lower casing portion or trap door 22 may include a plurality of apertures that align with and receive the user-actuatable inputs 20 when the lower casing portion 22 is attached at the mirror head, such as via snap-attaching to the mirror casing 14 and/or via snap-attaching to a backplate 24 of the mirror reflective element assembly. The mirror casing includes an aperture through which the mounting structure extends for pivotally attaching the mirror head at the mounting structure. As shown in FIG. 2, the mirror casing 14 and the lower casing portion or sensor casing 22 combine to form the aperture through which the mounting structure extends.

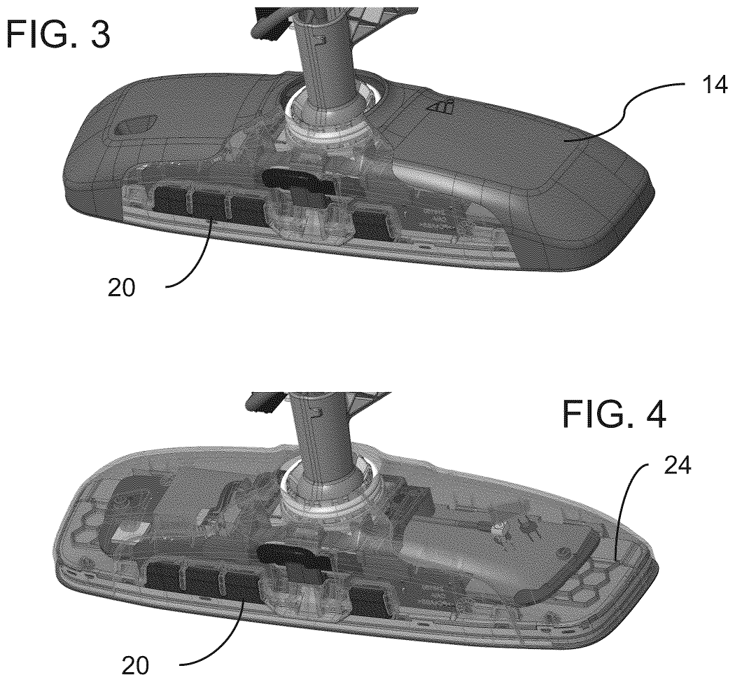

In the illustrated embodiment of FIGS. 3-5, the mirror assembly includes a full-sized electronic video display and operates in a selected one of a reflective mode (where the driver views rearward of the vehicle via reflections off the mirror reflector) or a display mode (where the driver views video images displayed by the video display screen within the mirror head and behind the mirror reflective element). The mirror head has a plurality of user-actuatable inputs 20 for human machine interface (HMI), such as for camera toggling, display settings (e.g., pan, tilt, zoom, intensity, etc.). The user inputs 20 include tactile buttons and light sources (e.g., light emitting diodes (LEDs) or other suitable light sources) disposed at a rigid printed circuit board (PCB) within the mirror head, including laser-etched button caps. The lower casing portion or trap door 22 is formed with apertures that, when the lower casing portion 22 is attached at the mirror head, receive the button caps at least partially through the lower casing portion. This provides access to the inputs 20 exterior of the mirror head to receive inputs from an occupant of the vehicle. The configuration thus has a lower casing portion that is separate from the button board, with the microcontroller for the button logic on the main PCB within the mirror head.

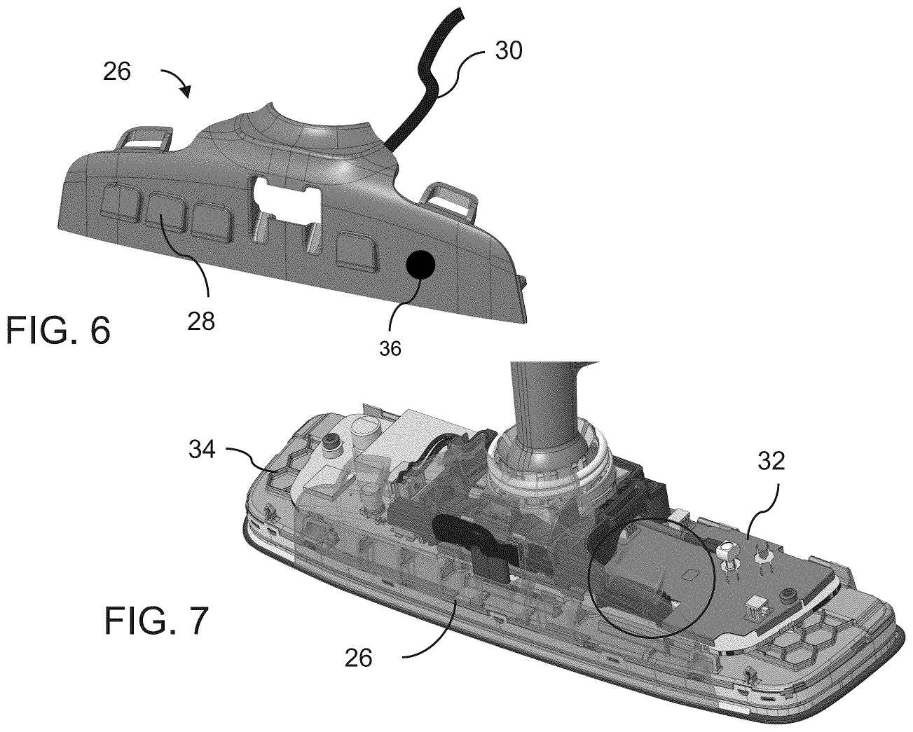

As shown in FIGS. 6 and 7, a lower casing portion or trap door 26 for the mirror head casing 14 includes a plurality of user-actuatable capacitive touch sensors 28, which are integrally formed within the lower casing portion 26. The touch sensors 28 are electrically connected to a flexible circuit element 30 (e.g., a ribbon cable or flexible printed circuit (FPC) tail or wire or the like), which is electrically connected to circuitry of a printed circuit board 32 at the backplate or attachment plate 34 at the rear of the mirror reflective element. The lower casing portion 26 (with the user-actuatable capacitive touch sensors formed therein) is electrically connected to the circuitry and is snap-attached at the mirror head, such as via snap-attaching to the mirror casing 14 and/or the backplate 34 of the mirror reflective element assembly, without requiring alignment of apertures with touch sensors or inputs at the circuit board.

The touch sensors 28 are formed within the lower casing portion 26 by screen printing circuitry (e.g., electrically conductive ink) on a thermoformable film (e.g., polycarbonate), including printing electronics onto the film (e.g., conductive circuitry, touch controls, antennas and/or proximity sensors), and surface mounting electrical components (e.g., LEDs, transistors, resistors, capacitors, etc.) onto the thermoformable film circuit, such as by using conductive and/or structural adhesives. The circuit (which is typically flat when initially formed) is then shaped into the desired three-dimensional shape, such as a shape that matches the contours of interior portions of the casing portion 26 and/or the mirror casing 14. The formed electronics film substrate is insert molded using ordinary high pressure and high temperature molding materials, such as, for example, polycarbonate (PC) or PC+ABS or PC+ASA or PC and thermoplastic polyurethane (TPU) or the like, which results in a unitary structure with the electronics encapsulated within the polycarbonate (or other suitable material). The encapsulation of circuitry and/or electrical components within a formed element may utilize aspects of the in-mold structural electronics technology available from Tactotek Corporation and described at www.tactotek.com/technology.

The lower casing portion 26 with integrated capacitive touch sensors thus provides a unitary, single in-mold structural electronic (IMSE) component with capacitive touch sensor circuitry (pads and transistors) and LEDs. A preferred material is PC+ABS, but other suitable materials may be utilized. The IMSE component may be the lower casing portion or trap door 26 or optionally the entire housing or mirror casing 14 may be formed with the touch sensors integrated therein. The IMSE component may include the same material as the main housing or mirror casing 14 or may include a different material than the main housing body or may include the same or different color or texture as compared to the main housing, which allows for increased styling flexibility. The microcontroller operating or running the touch algorithm is located at the main mirror PCBA 32, and is common to the rest of the system (i.e., the same microcontroller operates the full mirror display and the touch sensing algorithm). The IMSE component has a FPC tail or discrete wire connection 30 that electrically connects the IMSE component to the main mirror PCBA 32. The user of the mirror assembly thus interfaces with exterior surface portions of the rigid insert molded component 26 to control the mirror or display settings.

Although shown and described as being implemented at a mirror head of an interior rearview mirror assembly, the IMSE design and user input integration is also suitable for applications in an exterior rearview mirror assembly or other vehicle components, such as, for example, an overhead console or center console, or a door handle or liftgate handle or the like.

Thus, the IMSE with user input integration provides simplified assembly and a reduction in component count. The IMSE component provides a unitary component that is snap-attached at the mirror head and electrically connected to circuitry within the mirror head via a single electrical connection, while the previous trap door construction includes the trap door, the rigid button circuit board, and the button caps, which have to be aligned with the apertures of the trap door during assembly. The IMSE component provides encapsulation of the electronics (which includes the sensors and may also include a microcontroller, IR LEDs, etc.), which provides increased ingress protection and less risk of scrap during mirror assembly. The IMSE component also provides improved styling (seamless) by providing capacitive touch sensors (which may be disposed along a smooth contour-matching profile of the casing portion) instead of tactile buttons protruding through the trap door.

Put another way, the mirror assembly includes the plurality of user actuatable inputs 28 at a lower portion of the mirror casing 14. The user actuatable inputs 28 include respective portions of the exterior surface of the mirror casing 14 that, when engaged by the user, control operation of one or more elements or accessories or systems of the vehicle. In the illustrated example of FIGS. 6 and 7, electronic components of the inputs 28 (e.g., sensors for sensing the user input, LEDs for illuminating or backlighting the inputs and/or haptic feedback actuators for providing tactile feedback to the user when the input is actuated) are encapsulated within the lower portion of the mirror casing 14. Further, the lower portion of the mirror casing 14 comprises a separate lower casing portion 26 that is attachable to the mirror casing 14 and at least partially received within the mirror head. When attached to the mirror head, an electrical connector of the flexible PCB 30 connects the actuatable inputs 28 to power and control circuitry at the main PCBA 32 of the mirror head.

Each user actuatable input 28 may correspond to a raised or protruding portion of the lower casing portion 26. This may help the user identify portions of the mirror casing 14 that can be engaged to control operation of the one or more systems of the vehicle. In some examples, the lower casing portion 26 may include a substantially smooth or continuous surface with respective icons or indicia disposed at the lower casing portion 26 and corresponding to positions of the user actuatable inputs 28. The LEDs may backlight or illuminate the icons.

The inputs 28 may control operation of the mirror assembly, such as to adjust the mirror assembly between the video display mode and the mirror display mode, to adjust brightness of videos displayed at the mirror assembly, and the like. Further, individual inputs 28 may allow the driver or occupant to adjust the videos displayed at the mirror assembly, such as to switch between views provided by different cameras at the vehicle, to digitally adjust the video images (e.g., pan, tilt, zoom, and the like), to switch between a day display mode (e.g., displaying color images derived from image data representative of visible light) and a night display mode (e.g., displaying black and white or grayscale images derived from image data representative of infrared or near infrared light). Optionally, the inputs 28 may control operation of other systems of the vehicle, such as a telecommunications system of the vehicle (e.g., to answer a phone call, end a phone call, and the like), a navigation system of the vehicle, and the like.

Optionally, the video display screen may display icons or images that are viewable at the lower edge portion of the mirror reflective element and that correspond to the inputs 28 at the lower portion of the mirror head. That is, the video display screen displays icons corresponding to the functions controlled by the inputs 28 and at positions of the mirror reflective element corresponding to the positions of the inputs 28. The icons may be displayed when the video display screen is operating to display video images to provide the rearward view to the driver of the vehicle and/or the icons may be displayed when the video display screen is not operating to display the rearward view and the mirror reflector is providing the rearward view to the driver of the vehicle. For example, the icons may appear through the mirror reflective element or as an overlay at the reflections provided by the mirror reflective element. The mirror assembly and video display screen may utilize characteristics of the mirror assemblies described in International PCT Application No. PCT/US2025/027018, filed Apr. 30, 2025 (Attorney Docket DON01 FP5369WO), which is incorporated herein by reference in its entirety.

In some examples, the lower casing portion 26 may accommodate one or more infrared (IR) or near infrared (NIR) light sources 36 encapsulated within the wall structure of the lower casing portion 26. Corresponding portions of the lower casing portion 26 may be at least partially transmissive of IR or NIR light so that, when electrically operated, the light sources 36 emit light that passes through the lower casing portion 26 and illuminates regions within the interior cabin of the vehicle. This IR or NIR illumination may, for example, illuminate a driver's head region or a driver region or a passenger region of the interior cabin for a driver monitoring system or occupant monitoring system or cabin monitoring system of the vehicle. In particular, with the lower casing portion 26 disposed at the lower portion of the mirror head, the light sources 36 may direct IR or NIR light generally downward from the mirror head, such as to illuminate driver or passenger footwells, the steering wheel (e.g., for driver hand detection), the dashboard or center stack, and the like. The lower casing portion may thus be at least partially transmissive to IR or NIR light (i.e., at least a portion of IR or NIR light incident at the lower casing portion passes through the lower casing portion) and block at least a portion of visible light incident at the lower casing portion 26 to hide or render covert the light sources from view of the driver. Thus, the main portion of the mirror head may accommodate the camera that views through the mirror reflective element for driver monitoring while the lower casing portion 26 accommodates light sources 36 for IR or NIR illumination. The light sources 36 may include one or more IR or NIR light emitting diodes (LEDs) or vertical-cavity surface-emitting lasers (VCSEL) or the like.

The mirror reflective element may comprise a laminate construction variable reflectance electro-optic (such as electrochromic) reflective element assembly having a front substrate and a rear substrate with an electro-optic medium (such as electrochromic medium) sandwiched therebetween and bounded by a perimeter seal, such as by utilizing aspects of the mirror assemblies described U.S. Pat. Nos. 7,626,749; 7,274,501; 7,255,451; 7,195,381; 7,184,190; 6,690,268; 6,449,082; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,066,112; 5,142,407 and/or 4,712,879, which are hereby incorporated herein by reference in their entireties.

The mirror casing may include a bezel portion that circumscribes a perimeter region of the front surface of the reflective element, or the perimeter region of the front surface of the reflective element may be exposed (such as by utilizing aspects of the mirror reflective elements described in U.S. Pat. Nos. 8,508,831 and/or 8,730,553, and/or U.S. Publication Nos. US-2014-0022390; US-2014-0293169 and/or US-2015-0097955, which are hereby incorporated herein by reference in their entireties).

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

Although shown as an electrochromic mirror application, it is envisioned that the mirror assembly may comprise a prismatic mirror reflective element or non-laminate mirror reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 7,420,756; 7,338,177; 7,289,037; 7,274,501; 7,249,860; 6,318,870, 6,598,980; 5,327,288; 4,948,242; 4,826,289; 4,436,371 and/or 4,435,042, and/or U.S. Publication No. US-2010-0085653, which are hereby incorporated herein by reference in their entireties.

The mirror assembly may include user actuatable inputs operable to control any of the accessories of or associated with the mirror assembly and/or an accessory module or the like. For example, the mirror assembly may include touch sensitive elements or touch sensors or proximity sensors, such as the types of touch sensitive elements described in U.S. Pat. Nos. 5,594,222; 6,001,486; 6,310,611; 6,320,282; 6,627,918; 7,224,324 and/or 7,253,723, and/or U.S. Publication Nos. US-2014-0022390 and/or US-2014-0293169, which are hereby incorporated herein by reference in their entireties, or such as proximity sensors of the types described in U.S. Pat. Nos. 7,224,324; 7,249,860 and/or 7,446,924, and/or U.S. Publication No. US-2006-0050018, which are hereby incorporated herein by reference in their entireties, or such as membrane type switches, such as described in U.S. Pat. No. 7,360,932, which is hereby incorporated herein by reference in its entirety, or such as detectors and the like, such as the types disclosed in U.S. Pat. Nos. 7,255,451; 6,504,531; 6,501,465; 6,492,980; 6,452,479; 6,437,258 and/or 6,369,804, which are hereby incorporated herein by reference in their entireties, and/or the like.

Optionally, the user inputs or buttons may comprise user inputs for a garage door opening system, such as a vehicle based garage door opening system of the types described in U.S. Pat. Nos. 6,396,408; 6,362,771; 7,023,322 and/or 5,798,688, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; and 6,420,975; 6,477,464; 6,946,978; 7,308,341; 7,167,796; 7,004,593; 7,657,052 and/or 6,678,614, and/or U.S. Pat. Pub. No. US-2006-0050018, which are all hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 8,890,955; 7,855,755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736; and/or US-2010-0097469, which are all hereby incorporated herein by reference in their entireties.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International PCT Application No. PCT/US2025/027206, filed May 1, 2025 (Attorney Docket DON01 FP5372WO), and/or International Publication No. WO 2023/220222, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The camera includes a lens and imaging sensor. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least two million photosensor elements or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2021-0162926; US-2021-0155167; US-2018-0134217 and/or US-2014-0285666, and/or International Publication No. WO 2022/150826, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2021-0155167 and/or US-2019-0118717, and/or International Publication No. WO 2022/150826, which are all hereby incorporated herein by reference in their entireties.

Optionally, the DMS camera may be used to detect ambient light and/or glare light (emanating from headlamps of a trailing vehicle) for use in providing auto-dimming of the EC mirror reflective element. The DMS camera may be disposed in the mirror head and viewing rearward through the mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

Optionally, image data captured by a rearward-viewing camera (e.g., a rear backup camera or other rearward-viewing camera disposed at a rear portion of the vehicle, or a driver or occupant or cabin monitoring camera that views rearward within the cabin of the vehicle and rearward of the vehicle via a rear window of the vehicle) may be image processed to determine ambient light (and/or glare light) present at the vehicle. Thus, for example, during nighttime driving, image processing of captured image data can be used to appropriately control dimming of the mirror reflective element or the intensity of backlighting of a video display screen to be appropriate for nighttime driving. Also, for example, during high ambient driving, the backlighting is increased so the displayed images are not washed out. The intelligent/automatic mirror dimming functions and/or video display screen dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mirror head adjustable about a mounting base, wherein the mounting base is configured to mount the vehicular interior rearview mirror assembly at an interior portion of an interior cabin of a vehicle;
wherein the mirror head accommodates a mirror casing and a mirror reflective element;
wherein a sensor casing is formed separate from the mirror casing, and wherein the sensor casing includes a plurality of capacitive touch sensors encapsulated within a wall structure of the sensor casing;
wherein the sensor casing, with the plurality of capacitive touch sensors encapsulated within the wall structure, is attached to the mirror casing, and wherein, with the sensor casing attached to the mirror casing, an outer surface of the wall structure of the sensor casing comprises an outer surface of the mirror head; and
wherein, with the vehicular interior rearview mirror assembly mounted at the interior portion of the interior cabin of the vehicle, a system of the vehicle is controlled responsive to a user input at a portion of the outer surface of the wall structure of the sensor casing that corresponds to one or more of the plurality of capacitive touch sensors.

2. The vehicular interior rearview mirror assembly of claim 1, wherein the plurality of capacitive touch sensors comprises circuitry that is screen printed on a thermoformable film, and wherein a polymeric material is overmolded over the thermoformable film to form the wall structure and to encapsulate the plurality of capacitive touch sensors.

3. The vehicular interior rearview mirror assembly of claim 2, wherein the thermoformable film is flat during screen printing, and wherein the thermoformable film is shaped into a three-dimensional shape when the polymeric material is overmolded over the thermoformable film.

4. The vehicular interior rearview mirror assembly of claim 1, wherein, with the vehicular interior rearview mirror assembly mounted at the interior portion of the interior cabin of the vehicle, the sensor casing is attached at a lower region of the mirror casing and comprises a lower portion of the mirror head.

5. The vehicular interior rearview mirror assembly of claim 4, wherein the sensor casing snap-attaches at the lower region of the mirror casing.

6. The vehicular interior rearview mirror assembly of claim 4, wherein the sensor casing includes an electrical connector that electrically connects the plurality of capacitive touch sensors with circuitry within the mirror head when the sensor casing is attached at the lower region of the mirror casing.

7. The vehicular interior rearview mirror assembly of claim 1, wherein the sensor casing includes an electrical connector that electrically connects the plurality of capacitive touch sensors with circuitry within the mirror head when the sensor casing is attached at the mirror casing.

8. The vehicular interior rearview mirror assembly of claim 1, wherein the sensor casing snap-attaches at the mirror casing.

9. The vehicular interior rearview mirror assembly of claim 1, wherein the mirror head accommodates a video display screen that, with the vehicular interior rearview mirror assembly mounted at the interior portion of the interior cabin of the vehicle, and when the video display screen is electrically operated, displays video images that are viewable through the mirror reflective element.

10. The vehicular interior rearview mirror assembly of claim 9, wherein operation of the video display screen is at least in part controlled responsive to the user input at the portion of the outer surface of the wall structure of the sensor casing that corresponds to one or more of the plurality of capacitive touch sensors.

11. The vehicular interior rearview mirror assembly of claim 9, wherein the mirror head operates in one of (i) a reflecting mode where a driver of the vehicle views rearward of the vehicle via reflections at the mirror reflective element of the mirror head and (ii) a video display mode where the driver of the vehicle views video images displayed by the video display screen at the mirror reflective element.

12. The vehicular interior rearview mirror assembly of claim 11, wherein, with the mirror head operating in the video display mode, the video display screen is at least in part controlled responsive to the user input at the portion of the outer surface of the wall structure of the sensor casing that corresponds to one or more of the plurality of capacitive touch sensors.

13. The vehicular interior rearview mirror assembly of claim 1, wherein the sensor casing includes at least one light emitting diode encapsulated within the wall structure of the sensor casing.

14. The vehicular interior rearview mirror assembly of claim 1, wherein the sensor casing includes a near infrared (NIR) light source encapsulated within the wall structure of the sensor casing, and wherein, with the vehicular interior rearview mirror assembly mounted at the interior portion of the interior cabin of the vehicle, the NIR light source, when electrically operated to emit light, emits NIR light that passes through a portion of the sensor casing to illuminate a region of the interior cabin of the vehicle.

15. The vehicular interior rearview mirror assembly of claim 14, wherein the mirror head accommodates a cabin monitoring camera, and wherein, with the vehicular interior rearview mirror assembly mounted at the interior portion of the interior cabin of the vehicle, the cabin monitoring camera views at least a portion of the interior cabin of the vehicle, and wherein image data captured by the cabin monitoring camera is processed for at least one selected from the group consisting of (i) monitoring a driver of the vehicle and (ii) monitoring a passenger region within the interior cabin of the vehicle.

16. A method for manufacturing a vehicular interior rearview mirror assembly, the method comprising:
providing a mirror head adjustable about a mounting base, and wherein the mounting base is configured to mount the vehicular interior rearview mirror assembly at an interior portion of an interior cabin of a vehicle;
wherein the mirror head accommodates a mirror casing and a mirror reflective element;
screen printing a plurality of capacitive touch sensors on a thermoformable film;
overmolding a polymeric material over the thermoformable film to encapsulate the plurality of capacitive touch sensors within a wall structure of a sensor casing;
with the plurality of capacitive touch sensors encapsulated within the wall structure of the sensor casing, attaching the sensor casing at the mirror casing;
wherein, with the sensor casing attached at the mirror casing, an outer surface of the wall structure of the sensor casing forms part of an outer surface of the mirror head; and
wherein the plurality of capacitive touch sensors is configured to, with the vehicular interior rearview mirror assembly mounted at the interior portion of the interior cabin of the vehicle, receive a user input at a portion of an outer surface of the wall structure of the sensor casing that corresponds to one or more of the plurality of capacitive touch sensors for controlling a system of the vehicle responsive to the user input.

17. The method of claim 16, wherein the thermoformable film is flat during screen printing, and wherein the thermoformable film is shaped into a three-dimensional shape during overmolding of the polymeric material.

18. The method of claim 16, wherein attaching the sensor casing at the mirror casing comprises snap-attaching the sensor casing at the mirror casing.

19. The method of claim 16, wherein the sensor casing includes an electrical connector that electrically connects the plurality of capacitive touch sensors with circuitry within the mirror head when the sensor casing is attached at the mirror casing.

20. The method of claim 16, wherein the sensor casing attaches at a lower region of the mirror casing.

21. The method of claim 16, wherein the mirror head accommodates a video display screen that, with the vehicular interior rearview mirror assembly mounted at the interior portion of the interior cabin of the vehicle, and when the video display screen is electrically operated, displays video images that are viewable through the mirror reflective element.

22. The method of claim 21, wherein, responsive to the user input at the portion of the outer surface of the wall structure of the sensor casing that corresponds to one or more of the plurality of capacitive touch sensors, operation of the video display screen is at least in part controlled.

23. The method of claim 16, wherein the sensor casing includes at least one light emitting diode encapsulated within the wall structure of the sensor casing.

24. The method of claim 23, wherein the at least one light emitting diode comprises a near infrared (NIR) light source, and wherein, with the vehicular interior rearview mirror assembly mounted at the interior portion of the interior cabin of the vehicle, the NIR light source, when electrically operated to emit light, emits NIR light that passes through a portion of the sensor casing to illuminate a region of the interior cabin of the vehicle.

25. The method of claim 23, wherein the mirror head accommodates a cabin monitoring camera, and wherein, with the vehicular interior rearview mirror assembly mounted at the interior portion of the interior cabin of the vehicle, the cabin monitoring camera views at least a portion of the interior cabin of the vehicle, and wherein image data captured by the cabin monitoring camera is processed for at least one selected from the group consisting of (i) monitoring a driver of the vehicle and (ii) monitoring a passenger region within the interior cabin of the vehicle.

26. A vehicular interior rearview mirror assembly, the vehicular interior rearview mirror assembly comprising:
a mirror head adjustable about a mounting base, wherein the mounting base is configured to mount the vehicular interior rearview mirror assembly at an interior portion of an interior cabin of a vehicle;
wherein the mirror head accommodates a mirror casing and a mirror reflective element;
wherein a sensor casing is formed separate from the mirror casing, and wherein the sensor casing includes a plurality of capacitive touch sensors encapsulated within a wall structure of the sensor casing;
wherein the sensor casing, with the plurality of capacitive touch sensors encapsulated within the wall structure, is snap-attached to the mirror casing, and wherein, with the sensor casing snap-attached to the mirror casing, an outer surface of the wall structure of the sensor casing comprises an outer surface of the mirror head;
wherein the sensor casing includes an electrical connector that electrically connects the plurality of capacitive touch sensors with circuitry within the mirror head when the sensor casing is snap-attached at the mirror casing; and
wherein, with the vehicular interior rearview mirror assembly mounted at the interior portion of the interior cabin of the vehicle, a system of the vehicle is controlled responsive to a user input at a portion of the outer surface of the wall structure of the sensor casing that corresponds to one or more of the plurality of capacitive touch sensors.

27. The vehicular interior rearview mirror assembly of claim 26, wherein the plurality of capacitive touch sensors comprises circuitry that is screen printed on a thermoformable film, and wherein a polymeric material is overmolded over the thermoformable film to form the wall structure and to encapsulate the plurality of capacitive touch sensors.

28. The vehicular interior rearview mirror assembly of claim 27, wherein the thermoformable film is flat during screen printing, and wherein the thermoformable film is shaped into a three-dimensional shape when the polymeric material is overmolded over the thermoformable film.

29. The vehicular interior rearview mirror assembly of claim 26, wherein, with the vehicular interior rearview mirror assembly mounted at the interior portion of the interior cabin of the vehicle, the sensor casing is snap-attached at a lower region of the mirror casing and comprises a lower portion of the mirror head.

30. The vehicular interior rearview mirror assembly of claim 26, wherein the mirror head accommodates a video display screen that, with the vehicular interior rearview mirror assembly mounted at the interior portion of the interior cabin of the vehicle, and when the video display screen is electrically operated, displays video images that are viewable through the mirror reflective element, and wherein operation of the video display screen is at least in part controlled responsive to the user input at the portion of the outer surface of the wall structure of the sensor casing that corresponds to one or more of the plurality of capacitive touch sensors.
